(19) United States
(12) Patent Application Publication
(10) Pub. No.: US 2011/0093093 A1
(43) Pub. Date: Apr. 21, 2011

(54) SYSTEM AND METHOD FOR REMOTELY CONTROLLING MACHINES

(76) Inventors: Gang Yang, Shaanxi (CN); Bin He, Shandong (CN); Kankan Zhang, Shandong (CN)

(21) Appl. No.: 12/745,369

(22) PCT Filed: Nov. 27, 2008
(86) PCT No.: PCT/CN08/73218

§ 371 Date: Jan. 6, 2011

(30) Foreign Application Priority Data
Nov. 30, 2007 (CN) 200710196339.3

(51) Int. Cl. G05B 15/00

(52) U.S. Cl. 700/12; 700/11

(57) ABSTRACT

A system and method for safely managing a machine is provided. The present disclosure may conduct to determine the work condition of machine when a remote instruction is received via a mobile communication system. The received instruction may be carried out only if the machine is in a safe situation.

### TECHNICAL FIELD

The present disclosure generally relates to remotely control machines, more particularly, to a system and method of remotely disabling machines provided with a Global Position System (GPS) device.

### BACKGROUND

In order to successfully schedule and accurately locate equipments, such as heavy earth moving machines and related equipment, for rental or for sale, a position locating system or an object tracking system is often utilized to accurately pinpoint the location of the machine. Only when the location of the machine is correctly located and mapped, the machine can then be scheduled or repossessed for subsequent dispatch.

The position locating system is a system used to determine the geographic location of the machine. Typically, the system operates with a processor, a software system and a GPS receiver device. When the GPS receiver device is installed on the machine it can then be remotely located and managed by a GPS receiver device coupled with local cellular communication system. Such use of GPS and cellular systems, machines can be accurately located and thereby managed efficiently and effectively.

It's known to remotely control a machine by using a host data processing system, by deactivate or shutting-down the machine when it is off site. However, it may not be suitable to shut down the machine on site unless it is not being used. For example, U.S. Pat. No. 6,657,534B1 sets forth a method to issue a shutdown command or trigger the machine to enter a low power standby mode. However, the 534' reference doesn't disclose a mechanism and/or strategy to manage the shut down operation perhaps when the machine is not being used or when the machine is not in a compromised situation.

The machine can be in various circumstances when it is in working condition. Some of which may not operation and at risk if the machine were disabled. For example, the machine can be in a temporary parking position when taking a break from work versus in a long term parking condition. And, only when the machine is in a long-term parking condition, the shut down instruction may be appropriate.

Moreover, if the machine had previously been designated as lost or stolen it may be benefited to shut down the machine right away to avoid further loss or prevent the machine from vanishing. Thus, the machine work status, it would be desirable to consider when a shut down instruction is being contemplated. Perhaps it would be further desired to consider the working time period in the work status determination process.

The present disclosure is directed to provide solutions to the remote control of machines according to their work statuses, and overcome one or more of the deficiencies set forth above.

### SUMMARY OF THE DISCLOSURE

In one aspect, the present disclosure is directed to a system for safely managing a machine. The system may include a receiving unit for receiving instruction from a remote controller entity and a determining unit for determining the work condition of the machine. The system may also include an executing unit for either carrying out or rejecting the instruction received from the remote controller entity. Furthermore, the system may include a transmitting unit for transmitting response generated by the determining unit to the remote controller entity.

In another aspect, the present disclosure is directed to a method for safely managing a machine. The method includes receiving instruction from a remote controller entity. The work condition of the machine may be determined when the machine receives the instruction. The method may also include carrying out the instruction received from the remote controller entity. Additionally, the method may include transmitting a response generated from work condition determination to the remote controller entity.

In another aspect, the present disclosure is directed to a method for safely shutting down a remote machine. The method may include receiving instruction from a remote controller entity. Determining the work condition of the machine to either carrying out or rejecting the instruction received from the remote controller entity may be conducted. The method may also include transmitting a response generated from work condition determination to the remote controller entity. The method may further include checking a status of the machine stored at the remote controller entity to decide whether to amend a plurality of pre-set parameters.

### BRIEF DESCRIPTION OF THE DRAWINGS

FIG. 1 is an exemplary illustration of a system according to the present disclosure.

FIG. 2 is an exemplary block diagram of a GPS device mounted in a machine according to the present disclosure.

FIG. 3 is an exemplary flowchart of the method according to the present disclosure.

FIG. 4 is an exemplary illustration of some components working together for determination step 306 of FIG. 3 according to the present disclosure.

### DETAILED DESCRIPTION

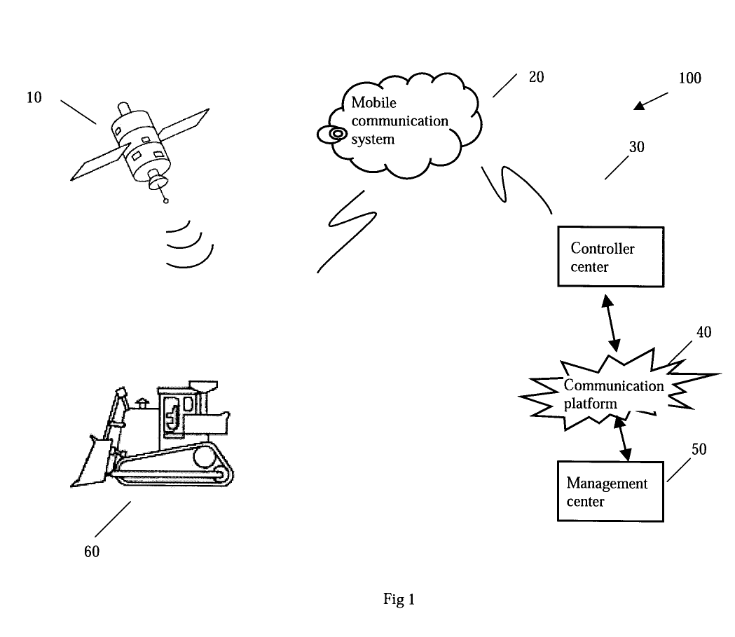

FIG. 1 illustrates an exemplary system 100 including a machine 60 configured to perform an operation associated with a particular industry, such as mining, construction, farming, etc. Other examples of machines may include, but should not be limited to, vocational machines, such as trucks, cranes, earth moving vehicles, mining vehicles, backhoes, material handling equipment, farming equipment, marine vessels, aircraft, and any type of movable machine. A machine may be powered by a combustion engine, an electric motor, or any other propulsion means known to those skilled in the art.

In one exemplary embodiment of the present disclosure, system 100 may include mobile communication system 20 to transmit information between machine 60 and remote entities, for example, controller center 30 shown in FIG. 1. Mobile communication system 20 could be a satellite system, a cellular network, or other network. Mobile communication system 20 may operate on 2G cellular standards, such as, for example, CDMA (Code Division Multiple Access), GSM (Global System for Mobile Communications), and TDMA (Time Division Multiple Access). Alternatively, or in addition, it may also operate on 2.5G and/or 3G standards, such as, for example, GPRS (General Packet Radio Service), TD-SCDMA (Time Division-Synchronous Code Division Multiple Access) and WCDM (Wideband Code Division Multiple Access). In addition, mobile communication system 20 may be operated by one or any combination of cellular network providers.

The information and/or instruction wherein is transmitted may be voice, data, or image. In an exemplary embodiment, transmission information through mobile communication system 20 could be SMS (Short Message Service). It should be apparent to those skilled in the art that other software application platforms could also be implemented to transfer information between machine 60 and controller center 30, such as instant communication software.

Referring to FIG. 1, system 100 may also include controller center 30. In an exemplary embodiment, controller center 30 may be configured to monitor and manage a machine or a fleet of machines. The machine owner or business owner may have up-to-date machine status, for example, such as machine ID and machine work status. Controller center 30 may be used as a platform to send instructions to machine 60 via mobile communication system 20. Additionally, controller center 30 may dispatch command information to determine some machine parameters for controlling machine 60.

Alternatively, controller center 30 may be configured to a central data distribution system for dispatching machine data to its respective management center. In an exemplary embodiment, controller center 30 may communicate with a plurality of off-board management centers through communication platform 40. Management center 50 may send out instructions and commands to control machine operations and may also transmit information to set certain machine parameters for managing machine 60.

Communication platform 40 may be a cellular network, or other network, such as Bluetooth, microwave, point-to-point wireless, point-to-multipoint wireless, multipoint-to-multipoint wireless, or any other appropriate communication platform may be used for networking a number of components.

System 100 may also include GPS satellite 10 and a GPS receiver (not shown) mounted in machine 60 for obtaining machine location information. Machine location information may be forwarded to controller center 30 and/or management center 50. It's very important for rental businesses to track rental machines location to lessen the risk of loss, therefore controller center 30 or management center 50 is configurable to lock or inactivate such machine if certain conditions are met, such as the machine being out of an approved range. In such situation, a shutdown instruction may be sent out to machine 60 via mobile communication system 20.

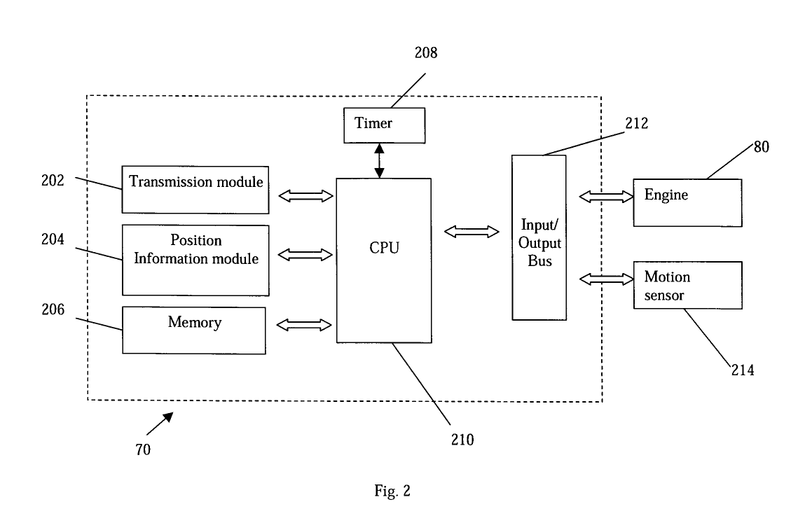

FIG. 2 shows an exemplary block diagram of GPS device 70 which may be mounted in machine 60 according to the present disclosure. GPS device 70 may include position information module 204 to obtain machine location by communication with GPS satellite 10. GPS device 70 may also include transmission module 202 to transmit required machine information and/or instruction between machine 60 and controller center 30. As shown in FIG. 2, GPS device 70 may further include CPU 210, memory 206 and Input/Output bus line 212 configured to communicate with other components of machine 60, for instance engine 80.

CPU 210 may obtain machine location information from position information module 204 and machine work information from engine 80 via Input/Output bus 212, and receive instruction data from transmission module 202. CPU 210 may also store machine information and instruction data in a storage device, such as memory 206. In addition, CPU 210 may determine whether to carry out an instruction based on analysis of machine work condition.

GPS device 70 may also include a device, for example timer 208 shown in FIG. 2, for generating a signal to send to CPU 210, to remind CPU 210 systematically and periodically to determine machine work condition. Further more, GPS device 70 may additionally include a sensor to detect if the machine is in operation, through motion sensor 214. Motion sensor 214 may communicate with CPU 210 through Input/Output bus 212.

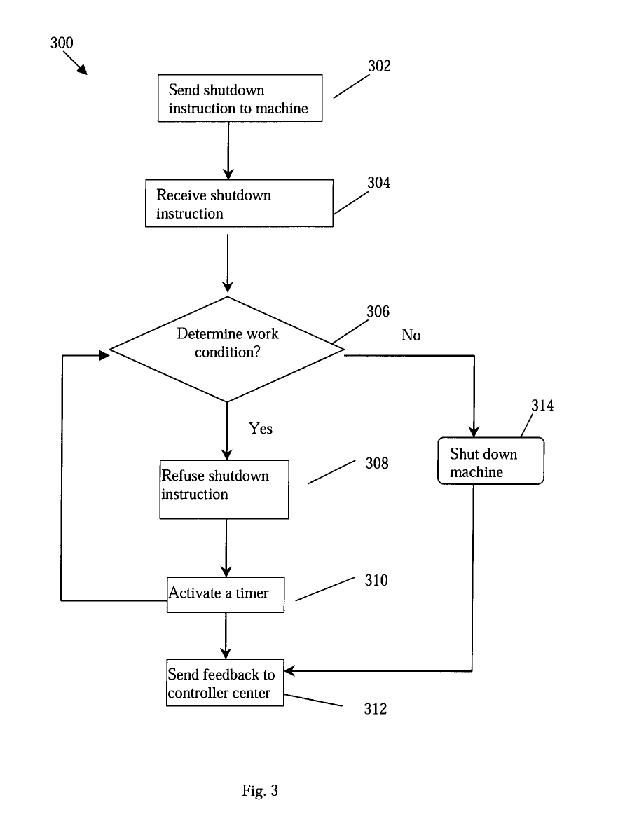

Referring to FIG. 3, communication between the machine and a remote entity will now be described. Communication method 300 includes a controller center 30 and a management center 50 provided to send a shutdown instruction to machine 60 (Step 302) when a predetermined event occurs. For example, if a renter of machine 60 has an overdue payment, a shutdown command may be sent to machine in Step 302.

As part of normal operation for mobile communication system 20, CPU 210 (within machine 60) receives a shutdown instruction (Step 304) and thereafter CPU 210 may initiate the determination of the work condition of machine 60 (Step 306). If machine 60 is determined to be not in work condition, CPU 210 may send a signal to engine 80 to shutdown machine 60 (Step 306: No). Moreover, CPU 210 may send a message to controller center 30 over transmission module 202 (Step 312) to inform that the machine has been disabled.

If machine 60 is in a work condition, CPU 210 will refuse the shutdown instruction (Step 306: Yes). Thereafter, a signal may be sent to CPU 210 after a predetermined time to determine work condition. The signal in Step 310 could be generated by a timer, or sent out from the controller center 30 and/or management center 50. Additionally, CPU 210 may send a message to controller center 30 (Step 312) over transmission module 202 to indicate that the machine is working and not shut down yet.

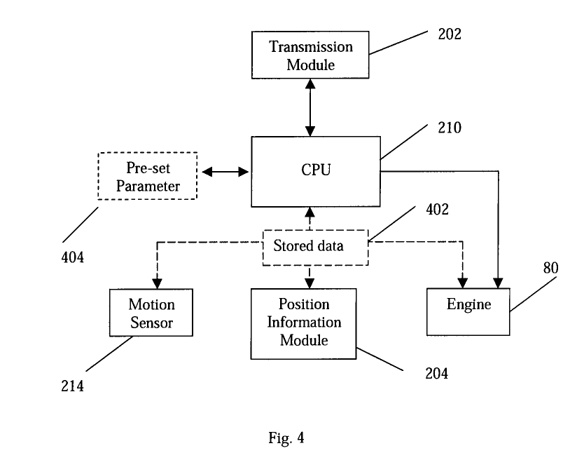

Further description of determination (step 306) is disclosed in FIG. 4 and will now be described. CPU 210 may check machine work condition history by comparing a pre-set parameter 404 with stored data 402 to determine whether the machine is in a work condition. Pre-set parameter 404 may be a past period in which the machine was dormant or a predetermined period of time, such as 30 minutes for example, that accordingly reflects the machine is likely not in use.

In an exemplary embodiment, stored machine data 402 may be machine data sent from motion sensor 214. If, however, the stored data simply indicates that the machine was moving at any time during the period, then machine 60 may be assumed it was working (i.e. in the work condition).

Alternatively, stored machine data 402 may include engine work data, such as the R signal of engine 80, for example. If, however, the stored data simply indicates that the machine engine was active at any time during the period, then the machine 60 may be assumed to be in the work condition.

Alternatively, machine location information may be used via position information module 204, as stored data 402 over a sample period. If, however, the stored data sample indicates that the location information has changed for the period, then machine 60 may be assumed to be in the work condition.

Pre-set parameter 404 may be pre set according to the machine type, or based on customary usage and conditions. Controller center 30 or management center 50 may have machine information, including machine history work information, history location information, history status. If a machine is deemed missing or stolen, pre-set parameter 404 may be adjusted smaller. For example, when controller center transmits the shutdown instruction, an additional instruction to amend the parameter may be transmitted as well.

It is contemplated by the present disclosure that any combination of motion sensor 214, position information 204 or engine 80, or all of the aforesaid modules, or each independently may be used to create stored data over a sample period to then be compared with the associated pre-set parameters to determine whether a cork condition exists. For example, a hydraulic excavator adapted with transmission module 202 may use motion sensor data, position information data and engine data, to compare with the associated pre-set parameters to determine work condition. Since hydraulic excavators can work with little or no cab movement over a time period it may be prudent to identify engine work data as the primary stored data but to additionally take motion and position readings to ensure machine is not under a work condition before shut down materializes.

### INDUSTRIAL APPLICABILITY

Although the present disclosure provides embodiments which are described in relation to machines and related equipment, such disclosure may be applicable to any environment or situation where it may be advantageous to utilize GPS system with local mobile communication system to process data with on-board GPS device and communicate to a remote controller center.

The disclosed system and method for safely selectively managing a machine could be used in an emerging market, especially for rental business. The disclosed system and method could be applied to safeguard rental assets by accurately tracking the location of rental machines and instructing shutdown when appropriate. Furthermore, it is envisioned that rental companies could operate their business with little additional costs by using the disclosed system and method since many of the communications are carried out on a cellular network.

Accordingly, the system and method provided by the present disclosure prevents the machine vandalism in emerging market by further strengthening the ability to control machine via a remote controller entity. For example, various strategies can be adopted by the remote controller entity to instruct an off-site machine to avoid vandalism or to save the machine battery life. One of the strategies available is to shut down the machine when the machine has not been working for a period of time.

Specifically, when a shut down instruction sent from the remote controller entity is received by a machine provided with a remote communication capability, a determination mechanism is activated to determine if the machine has not been working for a period of time. Only when the machine has not been in a working condition for a certain amount of time can the machine be shut down: referring to detailed description of FIG. 4.

Moreover, when a machine deemed missing or stolen comes into communication range, the remote controller entity can avoid further loss or damage by sending an instruction to shut down the machine. By amending the pre-set parameter to a shorter time interval or no interval, the machine will readily accept and process the instruction to shut down the machine thus disabling the machine. This will allow the rental business to mitigate loss and retrieve the machine.

It will be apparent to those skilled in the art that various modifications and variations can be made to the disclosed system and method for selective onboard processing of machine data. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A system for remotely managing a machine provided with remote communication capability through a mobile communication system the system comprises:
a transmission module configured to send and receive information between a remote entity and the machine;
a determining unit configured to determine the work condition of the machine;
wherein the executing unit for either carrying out or rejecting the instruction received from the remote controller entity; and
a transmitting unit for transmitting response generated by the determining unit to the remote controller entity.

2. The system as claimed in claim 1, wherein the determining unit determines machine work condition according to information retrieved from a plurality of machine members.

3. The system as claimed in claim 2, wherein the information retrieved from machine members includes a signal from an engine.

4. The system as claimed in claim 2, wherein the information retrieved from machine members includes a signal from a motion sensor.

5. The system as claimed in claim 2, wherein the information retrieved from machine members includes machine location from a position information module.

6. The system as claimed in claim 1, wherein the instruction received from the remote controller entity is to shut down the machine.

7. The system as claimed in claim 6, wherein the executing unit being configured to shut down the machine by carrying out the shut down instruction received from the remote controller entity if the machine is not in work condition.

8. The system as claimed in claim 7, wherein the executing unit being configured not to shut down the machine by rejecting the shut down instruction received from the remote controller entity if the machine is in work condition.

9. The system as claimed in claim 8, wherein the transmitting unit being configured to send a response to the remote controller entity by the transmitting unit if the shut down instruction is rejected.

10. The system claimed in claim 9 further including a timer for generating signal to remind the determining unit a later determination if the shut down instruction is rejected.

11. The system as claimed in claim 7, wherein the machine is not in work condition only if the machine stop working for a time period defined in a plurality of pre-set parameters.

12. The system as claimed in claim 11, wherein the time period is amended by the remote controller entity when a machine status stored at the remote controller entity shows the machine has been missing.

13. A method for safely managing a machine provided with remote communication capability through a mobile communication system comprising:
receiving instruction from a remote controller entity;
determining the work condition of the machine;
carrying out the instruction received from the remote controller entity; and
transmitting a response generated from work condition determination to the remote controller entity.

14. The method as claimed in claim 13, wherein the instruction received from the remote controller entity is to shut down the machine.

15. The method as claimed in claim 13 further including shutting down the machine by carrying out the instruction received from the remote controller entity by the executing unit if the machine is not in work condition.

16. The method as claimed in claim 15 further including sending a response to the remote controller entity if the shut down instruction is rejected.

17. The method claimed in claim 16 further including activating a timer if the shut down instruction is rejected.

18. The method as claimed in claim 13, wherein the machine work condition determination is based on information retrieved from a plurality of machine members.

19. The method as claimed in claim 18, wherein the information retrieved from machine members includes a signal from an engine.

20. The method as claimed in claim 18, wherein the information retrieved from machine members includes a signal from a motion sensor.

21. The method as claimed in claim 18, wherein the information retrieved from machine members includes machine location information from a position information module.

22. The method as claimed in claim 15, wherein the machine is not in work condition only if the machine stop working for a time period defined in the plurality of pre-set parameters.

23. The method as claimed in claim 24 further including amending the time period parameter when a machine status stored at the remote controller entity shows the machine has been missing.

24. A method for safely managing a machine provided with remote communication capability through a mobile communication system comprising:
receiving instruction from a remote controller entity;
determining the work condition of the machine to either carrying out or rejecting the instruction received from the remote controller entity;
transmitting a response generated from work condition determination to the remote controller entity; and
checking a status of the machine stored at the remote controller entity to decide whether to amend a plurality of pre-set parameters.

25. The method as claimed in claim 24 further including activating a timer if the instruction is not carried out according to the machine work condition determination.

26. The method as claimed in claim 24, wherein the work condition is determined based on information retrieved from a plurality of machine members including signals from an engine, a motion sensor, and a time period parameter of the plurality of pre-set parameters.

27. The method as claimed in claim 24 further comprises amending the time period parameter by the remote controller entity when the machine status shows the machine has been missing.
